(19) United States
(12) Patent Application Publication
(10) Pub. No.: US 2003/0066072 A1
(43) Pub. Date: Apr. 3, 2003

(54) System and method for voting on TV programs

(75) Inventors: Anthony Lionel Creed, San Diego, CA (US); Greg Gudorf, San Diego, CA (US); Aaron Dew, San Diego, CA (US); Matthew Chang, San Diego, CA (US); William Hausch, Culver City, CA (US)

Correspondence Address: John L. Rogitz, Rogitz & Associates, Suite 3120, 750 B Street, San Diego, CA, 92101, US

(73) Assignee: SONY CORPORATION, Tokyo (JP)

(21) Appl. No.: 09/970,504

(22) Filed: Oct. 3, 2001

(51) Int. Cl. H04N 7/16; H04H 9/00; H04N 7/173; H04N 7/025; H04N 7/10; G06F 3/00; H04N 5/445; G06F 13/00; H04N 9/76

(52) U.S. Cl. 725/10; 725/12; 725/34; 725/35; 725/37; 348/600

(57) ABSTRACT

A system and method for enhancing viewer group enjoyment of a TV program by providing a means for each viewer to express his opinion. Each viewer has a remote control device that can be used to generate votes, reviews, and decisions related to TV programs. These viewer expressions or results thereof are superimposed over the TV program being watched, so that viewers can express their opinions about a program non-verbally in a fun and relevant way. The TV can be automatically tuned or otherwise controlled based on the viewer expressions.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean forward” activities often are experienced by only a single person, while “lean back” activities are often group experiences. Moreover, “lean back” activities can extend to purchasing products that are advertised on TV, as opposed to, e.g., making products for sale. In any case, with the abovementioned critical observation of the present invention in mind, it can readily be appreciated that the differences between a system designed for “lean forward” experiences and a system designed for “lean back” experiences can be both subtle and profound.

An example of a “lean forward” system is the system known as “WebTV”, in which preselected Internet pages are loaded once into a television during manufacture and never subsequently updated, with the preselected pages being accessible through the television using a computer keyboard with its attendant complexity. To access the pages, the consumer must access a central site by means of the keyboard, and then be redirected to a desired Web page. In terms of currently expected speeds of Internet access, this consumes an undue amount of time. Furthermore, it requires browser or browser-like operations that must be executed by a consumer. All of these features—use of a keyboard, knowledgeable use of a browser, and wait time for Web page access—are not per se unacceptable for a lean forward experience, but would severely detract from a lean back experience.

For instance, in the context of lean back, entertainment-and group-oriented experiences, consumers are accustomed to using a much simpler input device than a computer keyboard, namely, a remote control, Moreover, a user interface that is simpler than a Web browser, e.g., an electronic program guide (EPG), is preferred. Also, waiting for entertainment to load or otherwise be prepared for playing is distracting in a lean-back, group-oriented experience. But as exemplified above by the WebTV system, current systems that attempt to integrate television and computers essentially do so by grafting a TV onto what is essentially an underlying, lean forward computer system, and consequently provide less than optimum lean back experiences. As an example, in a group lean back experience, several viewers might wish to share their opinions of a program with others viewing the program, without interrupting the viewing experience of the others by making verbal comments. The object of the present invention is to provide a TV system that accommodates lean back experiences better than existing systems.

### SUMMARY OF THE INVENTION

The invention provides a fun and unobtrusive way for members of a group of people watching a TV program to display opinions on-screen regarding the programs.

A system for presenting viewer-generated information on a TV includes at least first and second viewer input devices communicating with the TV. Each device is manipulable by a respective viewer to generate the viewer-generated information. A presentation of the information is superimposed onto a TV program display on the TV. The viewer-generated information can be, e.g., votes on what channel to watch, or reviews of a program being displayed, or group decisions related to TV programming.

In preferred non-limiting examples, the input devices are remote control devices that are in wireless communication with the TV. The presentation can be text, graphics, or audio.

In the exemplary implementation disclosed in greater detail below, each viewer input device can include a vote key that is manipulable by a viewer to configure the TV to receive vote signals. Also, each viewer input device may include a decide key that can be manipulated to generate a decide signal. Moreover, each viewer input device can include a review key that can be manipulated to enable a viewer to input a review of a program.

In another aspect, a method for enhancing TV use includes receiving, at a processor associated with a TV, at least first and second viewer expression signals related to TV programming. A display derived from the expression signals is presented on the TV.

In still another aspect, a system for facilitating viewer interaction with a televised program includes plural input means, potentially communicating via a computer network, that can be manipulated by respective viewers to indicate expressions related to one or more TV programs. Processor means, potentially external and accessible via a computer network, receive signals representing the expressions and generate an outcome signal based thereon. A TV coupled to the processor means, potentially via a wide area computer network, simultaneously displays the outcome signal with a TV program.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention;

FIG. 2 is a flow chart of the review logic;

FIG. 3 is a flow chart of the vote logic; and

FIG. 4 is a flow chart of the decision logic.

### DETAILED DESCRIPTION OF THE PREFERRED EMBODIMENTS

This invention provides a way for TV viewers to input expressions regarding TV programming by inputting various opinion formats and having the opinions displayed in some fashion on the TV, superimposed over the TV image.

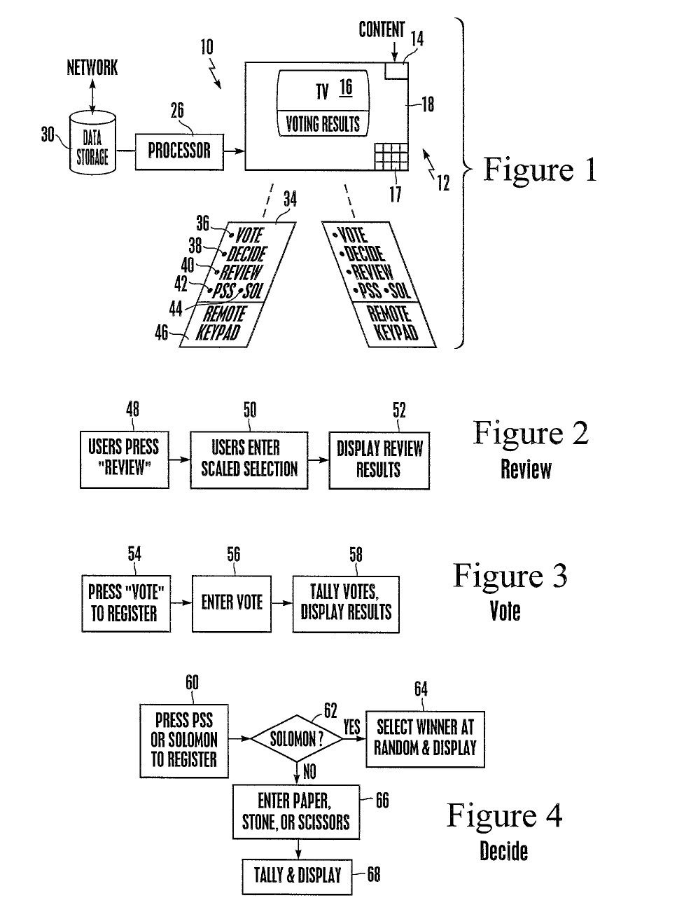

Referring initially to FIG. 1, a system is shown, generally designated 10. As shown, the system 10 includes a TV 12 that conventionally receives televised content at a content receiver 14 (e.g., an antenna, satellite dish, set-top box, etc.) for display of the content on a monitor 16 and associated speakers 17.

While the embodiment below discusses a TV 12 with a single housing that is shown separate from the microprocessor and database, it is to be understood that the term “television” encompasses any apparatus that has a television tuner and the below-described capability in a single housing or in separate housings that cooperate together. For instance, the term “TV” encompasses the television system shown in FIG. 1, as well as a conventional television in combination with a set-top box that functions in accordance with the present invention. In the latter example, the set-top box might include, e.g., the microprocessor discussed below.

In the preferred non-limiting embodiment shown, the TV 12 includes a housing 18 that holds a conventional television tuner which receives the TV signals. A microprocessor 26 communicates with the TV circuitry for presenting viewer expressions on the monitor 16/speakers 17 in accordance with the disclosure below. As intimated above, the microprocessor 26 can be located in the housing 18 or it can be disposed elsewhere, such as in a set-top box, remote control device, or other component, and may even be remote from the TV and accessed over, e.g., the Internet. In any case, the microprocessor 26 executes the logic set forth herein. The microprocessor 26 can also access a database 30 of viewer information, with the database 30 being contained in computer memory, or on a hard disk drive, optical drive, solid state storage, tape drive, removable flash memory, or any other suitable data storage medium and potentially accessible to a network such as the Internet.

It is to be understood that the microprocessor 26 controls certain functions of the TV 12 in accordance with the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

The system 10 also includes TV remote control devices 34 that communicate with the TV 12 via TV remote control IR or RF communication principles known in the art. According to the present invention, plural remote control devices 34 are provided, one for each viewer. Each remote control device 34 includes plural user-manipulable expression buttons for supporting the viewer expression functions discussed further below. Also, each remote device 34 sends signals that identify the particular viewer. Or, each remote control can have only conventional buttons, with viewer expressions of opinions being represented by predetermined manipulations of the buttons, e.g., “change input to DVD” or channel tuning.

As shown in FIG. 1, each remote control device 34 may include a vote button 36, a decide button 38, and a review button 40, to invoke respective exemplary non-limiting examples of viewer expression. Also, each device 34 can include a paper-stone-scissors (PSS) button 42 and a Solomon (SOL) button 44, as well as a keypad 46. The keypad 46 can contain alpha-numeric keys and conventional TV remote control device keys if desired.

According to present principles, viewers can generate viewer expressions by generating information using their remote control devices. It is to be understood that viewers participating in a group need not be in the same room, watching the same TV, but can be remote from each other and use respective systems 10, with the systems 10 communicating via the network indicated in FIG. 1.

FIG. 2 shows a first non-limiting example of viewer group interaction, specifically, a review function of the present invention. At block 48 a viewer can depress the review button 40 on his or her respective remote device 34. The signal or signals from the remote devices 34 are received by the TV 12, which informs the processor 26 so that the participating viewers can be registered. At block 50, the viewer enters his or her respective review selections. By way of non-limiting example, the numerals “1” through “5” on the keypad 46 can respectively indicate a five point scale from “excellent” through “poor” regarding the viewer's opinion of the program being televised.

The processor 26 tabulates the review results (if more than one viewer enters a review). An outcome signal is generated by the processor 26, with the outcome signal being used to drive a display of the review results on the monitor 16 and/or speaker 17 at block 52. As an example, appropriate text can be superimposed on the monitor 16 or potentially amusing graphics such as icons representing various review comments can be superimposed on the monitor 16. Or, a conventional control of the TV (such as a channel tuning button) can be manipulated based on the expression data. Or yet again, audio results can be superimposed over the TV audio displayed via the speakers 17 by playing a clip of, e.g., “Superb!” After a predetermined period, e.g., five seconds, the text/graphics can be removed from the monitor 16. Or, a viewer toggling a button on his remote device 34 can remove review results from the screen. Indeed, if desired in some implementations a viewer can disable the presentation of review results altogether by appropriately manipulating her remote device 34.

The flow chart of FIG. 3 shows another exemplary user expression method. Commencing at block 54, each viewer can depress his or her vote button 36, causing the viewer to be registered by the processor 26 for voting. Each viewer then votes by depressing an appropriate button on, e.g., the keypad 46. For instance, each viewer might depress a channel number on the keypad 46, to vote for that channel. The votes are tallied at block 58 and the outcome displayed on, e.g., the monitor 16. The results can be displayed in graphical, e.g., bar chart, format, or in any other appropriate format. Or, the outcome can be audibly displayed via the speakers 17, for example, by playing “Channel 3 wins!” over the speakers 17, and then channel 3 can be automatically tuned to, if desired.

Yet a third way for viewers to enter viewer-generated information to express themselves is shown in FIG. 4. Commencing at block 60, each viewer can depress the respective PSS button 42 or Solomon button 44 on the remote device 34 associated with that viewer. This registers the viewers at the processor 26, and informs the processor 26 that a decision is to be made. Decision diamond 62 simply indicates that when the Solomon method has been selected, the logic flows to block 64, wherein, in response to one of the users depressing the decide button 38 on his or her remote device 34, one of the viewers is selected at random (or pseudorandomly) as the winner. The results are displayed audibly or visually on the TV 12, with the winner then being able to select the channel/setting on the TV 12 he or she desires. To further add to the fun, the TV control features of losing viewers can be ignored by the TV 12 for a limited period of time.

On the other hand, if the viewers have selected PSS, the logic flows from decision diamond 62 to block 66, wherein each viewer appropriately manipulates his or her remote device 34 to enter one of stone, paper, scissors (or some other decision selector based on other conventions such as colors, numbers, and so on). At block 68, the processor determines the winner based on conventional PSS principles and displays the outcome in accordance with principles set forth herein. For a multiplicity of viewers the process shown at blocks 66 and 68 might have to be undertaken in several rounds to eliminate all viewers except the eventual winner.

While the particular SYSTEM AND METHOD FOR VOTING ON TV PROGRAMS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We claim:

1. A system for presenting at least one of first and second viewer-generated information on a TV, comprising:
at least one TV;
at least first and second viewer input devices communicating with the TV, each device being manipulable by a respective viewer to generate the viewer-generated information, a presentation of the information being superimposed onto a TV program display on the TV.

2. The system of claim 1, wherein the input devices are remote control devices.

3. The system of claim 1, wherein the input devices are in wireless communication with the TV.

4. The system of claim 1 wherein the presentation is text.

5. The system of claim 1, wherein the presentation is at least one graphic.

6. The system of claim 1, wherein each viewer input device includes at least one vote key manipulable by a viewer to configure the TV to receive vote signals.

7. The system of claim 1, wherein each viewer input device includes at least one decide key manipulable by a viewer to generate a decide signal.

8. The system of claim 1, wherein each viewer input device includes at least one review key manipulable to enable a viewer to input a review of a program.

9. The system of claim 1, further comprising a processor associated with the TV for processing the viewer-generated information.

10. A method for enhancing TV use, comprising:
receiving, at a processor associated with a TV, at least first and second viewer expression signals related to TV programming; and
presenting on the TV a display derived from the expression signals.

11. The method of claim 10, comprising selecting one of the expression signals as a winner.

12. The method of claim 11, comprising randomly selecting one of the expression signals as a winner.

13. The method of claim 10, comprising tallying the expression signals and presenting the results of a tally on the TV.

14. The method of claim 10, comprising receiving one of a plurality of decision selectors from each viewer, and determining a winner using the decision selectors.

15. The method of claim 14, wherein the decision selectors include rock, paper, and scissors.

16. A system for facilitating viewer interaction with a televised program, comprising:
plural input means manipulable by respective viewers to indicate expressions related to one or more TV programs;
processor means receiving signals representing the expressions and generating an outcome signal based thereon; and
at least one TV coupled to the processor means for simultaneously displaying the outcome signal with a TV program.

17. The system of claim 16, wherein the input means are wireless.

18. The system of claim 17, wherein the input means are TV remote control devices.

19. The system of claim 18, wherein the remote control devices include user expression buttons.

20. The system of claim 16, wherein the outcome signal is text.

21. The system of claim 16, wherein the outcome signal is at least one graphic.

22. The system of claim 16, wherein the outcome signal is an audio signal.

23. The system of claim 1, wherein control of the TV is automatically undertaken based on the viewer-generated information.
